(19) United States
(12) Patent Application Publication
(10) Pub. No.: US 2025/0119741 A1
(43) Pub. Date: Apr. 10, 2025

(54) Redundant Target for Notification in a Communication Network

(71) Applicant: Telefonaktiebolaget LM Ericsson (publ), Stockholm (SE)

(72) Inventors: Songmao Li, Shanghai (CN); Christine Jost, Dalby (SE); Sune Gustafsson, ÖXABÄCK (SE); Jesus De Gregorio, Madrid (ES)

(21) Appl. No.: 18/833,198

(22) PCT Filed: Jan. 24, 2023
(86) PCT No.: PCT/EP2023/051709

§ 371 Date: Jul. 25, 2024

(30) Foreign Application Priority Data
Jan. 28, 2022 (WO) PCT/CN2022/074544

(51) Int. Cl. H04W 12/08; H04W 12/06; H04W 48/18

(52) U.S. Cl. CPC H04W 12/08; H04W 12/06; H04W 48/18

(57) ABSTRACT

Network equipment is configured to operate as a service consumer. The network equipment transmits, to an authorization server, a request for an access token authorizing subscription by the service consumer to a notification from a service producer. The request indicates a notification redundant target for reselection of a target for the notification for example in case a notification target is not reachable, has de-registered or is associated with an error. The network equipment receives the access token from the authorization server in response to the request. The access token includes a claim asserting the notification redundant target. The service consumer includes the access token in a subscription request that requests subscription to a notification and is sent to a network equipment operating as a service producer.

### TECHNICAL FIELD

The present application relates generally to a communication network, and relates more particularly to a redundant target for a notification in such a network.

### BACKGROUND

The next generation (5G) core network (CN) uses a service-based architecture that leverages service-based interactions between CN network functions (NFs). NFs in this regard enable other authorized NFs to access their services. In particular, NFs can take on a producer role as a producer of a service and/or a consumer role as a consumer of a service. A service producer produces a service to a service consumer that is authorized to access that service.

In this context, a service consumer can request a subscription to a notification from the service producer, e.g., a callback notification or a subscription-related event notification. The subscription request can indicate a target to which the notification is to be sent, as well as a redundant target to which the notification is to be sent if the other endpoint is unreachable.

The service-based architecture advantageously enables greater flexibility and speed in the development of new CN services, as it becomes possible to connect to other components without introducing new interfaces. The service-based architecture also introduces the possibility to use application programming interfaces (APIs) based on web technology that makes development easier, as libraries and development tools for such technology are already broadly available. The service-based architecture nonetheless introduces security challenges. Challenges exist, for example, in ensuring that a redundant target indicated in a notification subscription request is authorized to receive the notification.

### SUMMARY

According to some embodiments herein, an access token authorizing subscription to a notification from a service producer includes a claim asserting that a certain redundant target for the notification is authorized. Some embodiments thereby exploit an access token authorizing the notification subscription for ensuring that the notification is sent to an authorized target, even when the primary target selected for the notification ends up being unreachable. In doing so, some embodiments advantageously prevent an unauthorized target from receiving the notification and/or maintain data confidentiality even upon notification failover.

More particularly, embodiments herein include a method performed by network equipment configured to operate as a service consumer. The method comprises transmitting, to an authorization server, a request for an access token authorizing subscription by the service consumer to a notification from a service producer. In some embodiments, the request indicates a notification redundant target for reselection of a target for the notification. The method also comprises receiving the access token from the authorization server in response to the request. In some embodiments, the access token includes a claim asserting the notification redundant target.

In some embodiments, the notification redundant target is to be selected as a target for the notification in case a notification target indicated by a request for a subscription to the notification is not reachable, has de-registered, or is associated with an error.

In some embodiments, the request includes a binding indication that indicates the notification redundant target. In one or more of these embodiments, the binding indication comprises a network function, NF, instance identity, an NF set identity, or an NF service set identity.

In some embodiments, the method further comprises transmitting, to the service producer, a subscription request that requests subscription to the notification from the service producer. In some embodiments, the subscription request indicates a notification target to target for the notification and also indicates the notification redundant target to target for the notification upon notification target reselection. In some embodiments, the subscription request includes the access token.

In some embodiments, the notification is a callback notification or a subscription event notification.

In some embodiments, the access token requested by the request is for authorizing subscription by the service consumer to multiple notifications from the service producer. In some embodiments, the request indicates multiple notification redundant targets for notification target reselection associated with the multiple respective notifications, and the access token includes multiple claims respectively asserting the multiple notification redundant targets. In one or more of these embodiments, the multiple notifications include a callback notification and a subscription event notification.

Other embodiments herein include a method performed by an authorization server. The method comprises receiving, from a service consumer, a request for an access token authorizing subscription by the service consumer to a notification from a service producer. In some embodiments, the request indicates a notification redundant target for reselection of a target for the notification. The method also comprises verifying the notification redundant target is authorized to receive the notification. The method also comprises transmitting the access token to the service consumer in response to the request. In some embodiments, the access token includes a claim asserting the notification redundant target.

In some embodiments, the notification redundant target is to be selected as a target for the notification in case a notification target indicated by a subscription to the notification is not reachable, has de-registered, or is associated with an error.

In some embodiments, the request includes a binding indication that indicates the notification redundant target. In one or more of these embodiments, the binding indication comprises a network function, NF, instance identity, an NF set identity, or an NF service set identity.

In some embodiments, the notification is a callback notification or a subscription event notification.

In some embodiments, the access token requested by the request is for authorizing subscription by the service consumer to multiple notifications from the service producer. In some embodiments, the request indicates multiple notification redundant targets for notification target reselection associated with the multiple respective notifications, and the access token includes multiple claims respectively asserting the multiple notification redundant targets. In one or more of these embodiments, the multiple notifications include a callback notification and a subscription event notification.

In some embodiments, verifying the notification redundant target is authorized to receive the notification comprises verifying that the notification redundant target matches an endpoint registered with the authorization server.

Other embodiments herein include a method performed by network equipment configured to operate as a service producer. The method comprises receiving, from a service consumer, a subscription request that requests subscription to a notification from the service producer. In some embodiments, the subscription request includes an access token with a claim asserting a notification redundant target to target for the notification upon notification target reselection.

In some embodiments, the subscription request indicates a notification redundant target to target for the notification upon notification target reselection. In some embodiments, the method further comprises verifying, based on the access token, the notification redundant target indicated by the subscription request as being authorized to receive the notification. In one or more of these embodiments, said verifying comprises verifying the notification redundant target indicated by the subscription request as being authorized to receive the notification if the notification redundant target indicated by the subscription request is the same as the notification redundant target asserted by the claim of the access token. In one or more of these embodiments, the method further comprises, upon notification target reselection, sending the notification to the verified notification redundant target.

In some embodiments, the notification redundant target is an endpoint to be selected as a target for the notification in case a notification target indicated by a request for the subscription requested is not reachable, has de-registered, or is associated with an error.

In some embodiments, the claim asserts the notification redundant target by asserting a binding indication. In some embodiments, the binding indication indicates the notification redundant target. In one or more of these embodiments, the binding indication comprises a network function, NF, instance identity, an NF set identity, or an NF service set identity.

In some embodiments, the notification is a callback notification or a subscription event notification.

In some embodiments, the subscription request requests subscription to multiple notifications from the service producer. In some embodiments, the access token includes multiple claims respectively asserting multiple notification redundant targets to target for the multiple respective notifications upon notification target reselection. In one or more of these embodiments, the multiple notifications include a callback notification and a subscription event notification.

Other embodiments herein include network equipment configured to operate as a service consumer. The network equipment comprises communication circuitry and processing circuitry. The processing circuitry is configured to transmit, to an authorization server, a request for an access token authorizing subscription by the service consumer to a notification from a service producer. In some embodiments, the request indicates a notification redundant target for reselection of a target for the notification. The processing circuitry is also configured to receive the access token from the authorization server in response to the request. In some embodiments, the access token includes a claim asserting the notification redundant target.

In some embodiments, the processing circuitry is configured to perform the steps described above for network equipment configured to operate as a service consumer.

Other embodiments herein include an authorization server comprising communication circuitry and processing circuitry. The processing circuitry is configured to receive, from a service consumer, a request for an access token authorizing subscription by the service consumer to a notification from a service producer. In some embodiments, the request indicates a notification redundant target for reselection of a target for the notification. The processing circuitry is also configured to verify the notification redundant target is authorized to receive the notification. The processing circuitry is also configured to transmit the access token to the service consumer in response to the request. In some embodiments, the access token includes a claim asserting the notification redundant target

In some embodiments, the processing circuitry is configured to perform the steps described above for an authorization server.

Other embodiments herein include network equipment configured to operate as a service producer. The network equipment comprises communication circuitry and processing circuitry. The processing circuitry is configured to receive, from a service consumer, a subscription request that requests subscription to a notification from the service producer. In some embodiments, the subscription request includes an access token with a claim asserting a notification redundant target to target for the notification upon notification target reselection.

In some embodiments, the processing circuitry is configured to perform the steps described above for network equipment configured to operate as a service producer.

Other embodiments herein include a computer program comprising instructions which, when executed by at least one processor of network equipment, causes the network equipment to perform the steps described above for network equipment. Other embodiments herein include a computer program comprising instructions which, when executed by at least one processor of an authorization server, causes the authorization server to perform the steps described above for an authorization server. In one or more of these embodiments, a carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communication network according to some embodiments.

FIG. 2 is a block diagram of a communication network according to other embodiments.

FIG. 3 is a call flow diagram of a subscription procedure between an NF service consumer and an NF service producer according to some embodiments.

FIG. 4 is a call flow diagram of a subscription procedure between an NF service consumer and an NF service producer according to other embodiments.

FIG. 5 is a call flow diagram of a procedure for acquiring an access token from an authorization server according to some embodiments.

FIG. 6 is a call flow diagram of a subscription procedure according to some embodiments.

FIG. 7 is a call flow diagram of a procedure for acquiring an access token from an authorization server according to some embodiments.

FIG. 8 is a call flow diagram of a subscription procedure between an NF service consumer and an NF service producer according to other embodiments.

FIG. 9 is a logic flow diagram of a method performed by network equipment configured to operate as a service consumer according to some embodiments.

FIG. 10 is a logic flow diagram of a method performed by an authorization server according to some embodiments.

FIG. 11 is a logic flow diagram of a method performed by network equipment configured to operate as a service producer according to some embodiments.

FIG. 12 is a block diagram of network equipment configured to operate as a service consumer according to some embodiments.

FIG. 13 is a block diagram of an authorization server according to some embodiments.

FIG. 14 is a block diagram of network equipment configured to operate as a service producer according to some embodiments.

FIG. 15 is a block diagram of a communication system in accordance with some embodiments

FIG. 16 is a block diagram of a user equipment according to some embodiments.

FIG. 17 is a block diagram of a network node according to some embodiments.

FIG. 18 is a block diagram of a host according to some embodiments.

FIG. 19 is a block diagram of a virtualization environment according to some embodiments.

FIG. 20 is a block diagram of a host communicating via a network node with a UE over a partially wireless connection in accordance with some embodiments.

### DETAILED DESCRIPTION

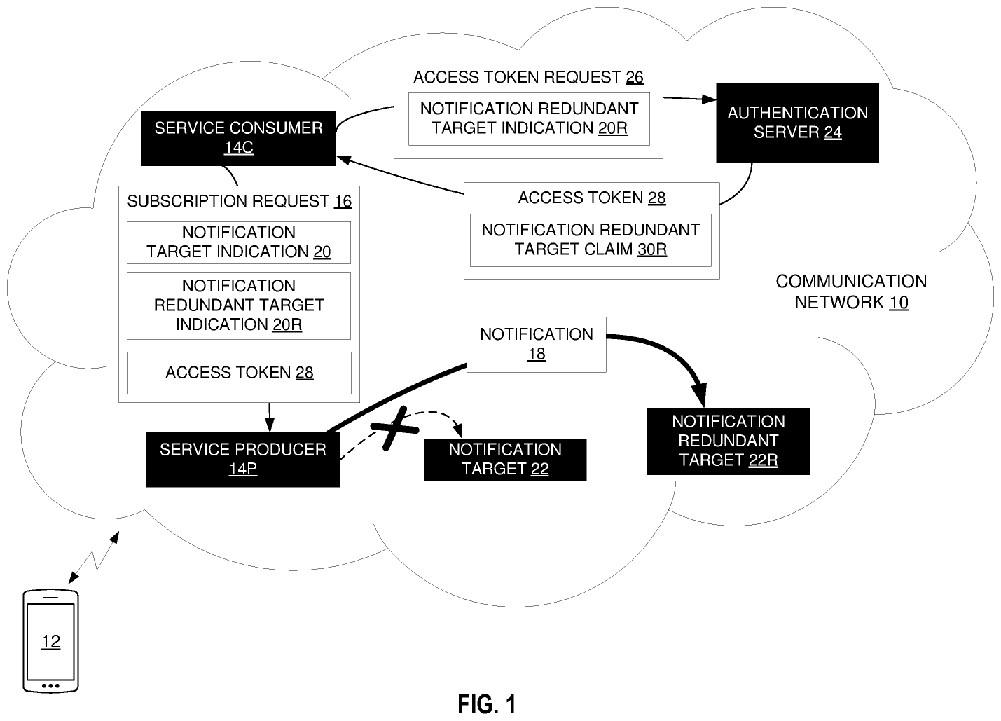

FIG. 1 shows a communication network 10 according to some embodiments. The communication network 10 as shown provides communication service to a communication device 12, e.g., which may take the form of a wireless communication device.

In one or more embodiments, the communication network 10 has a service-based architecture that leverages service-based interactions between network functions (NFs). Each NF may be implemented by network equipment either as a network element on dedicated hardware, as a software instance running on dedicated hardware, or as a virtualized function instantiated on an appropriate platform, e.g., on a cloud infrastructure. In a 5G network, for instance, NFs in the control plane may include an access and mobility management function (AMF), a session management function (SMF), a policy control function (PCF), an authentication server function (AUSF), a unified data management (UDM) function, etc.

An NF may provide its services to other authorized NFs that consume those services. An NF may thereby take on a producer role as a provider of a service (NF service producer) and/or a consumer role as a consumer of a service (NF service consumer). FIG. 1 for example shows a service producer 14P in the communication network 10 provides a service to any authorized consumer of that service. A service consumer 14C as shown may for example consume the service if authorized to do so.

In this context, the service consumer 14C in FIG. 1 transmits an access token request 26 to an authorization server 24. The access token request 26 requests an access token 28 authorizing subscription by the service consumer 14C to a notification 18 from the service producer 14P.

In some embodiments, the notification 18 is a subscription event notification, i.e., a notification of an event related to the subscription itself. The subscription event notification may for instance include a notification about an event associated with a change in the subscription, e.g., a modification or cancellation of the subscription. In other embodiments, the notification 18 is a callback notification, e.g., a callback notification about the occurrence of a certain event.

In any event, upon verifying that subscription to the notification 18 by the service consumer 14C is authorized, the authentication server 24 generates an access token 28, e.g., in the form of an OAuth2 access token or a JavaScript Object Notation (JSON) Web Token. The access token 28 constitutes proof that the authentication server 24 vouches for the fact that subscription by the service consumer 14C to the notification 18 is authorized. The authentication server 24 then transmits this access token 28 to the service consumer 14C.

The service consumer 14C includes the received access token 28 in a subscription request 16. The subscription request 16 requests subscription to the notification 18 from the service producer 14P. The subscription request 16 may do so on behalf of the service consumer 14C itself or on behalf of a different service consumer (not shown). By including the access token 28 in the subscription request 16, the service consumer 14C asserts authorization for the subscription, with that authorization being based on and/or evidenced by the access token 28.

The service consumer 14C generates the subscription request 16 to also include a notification target indication 20. The notification target indication 20 indicates a notification target 22 that the service producer 14P is to target for the notification 18, i.e., the primary target that the service producer 14P is to select for the notification 18. The notification target indication 20 may for instance take the form of an address or universal resource indicator (URI) of the notification target 22. In some embodiments, the notification target 22 may take the form of an endpoint and/or a destination URI (or a host part thereof) where the notification 18 is to be sent.

In some embodiments, such as may be the case when the notification 18 is a subscription event notification, the notification target 22 may be or be implemented at the service consumer 14C itself. In other embodiments, the notification target 22 may be or be implemented at a different service consumer or other network equipment not shown.

The subscription request 16 however also accounts for the possibility that the notification target 22 might not be reachable when the notification 18 is to be sent. If the notification target 22 is not reachable, the service producer 14P must select a different target for the notification 18, i.e., a redundant target. Selection of a different target for the notification 18 in this regard is referred to as reselection of the target for the notification 18. The subscription request 16 accordingly also includes a notification redundant target indication 20R that indicates a notification redundant target 22R for reselection of the target for the notification 18. According to the subscription request 16, then, the service producer 14P is to select the notification redundant target 22R as the target for the notification 18 in case the notification target 22 is not reachable, has de-registered, or is associated with an error. That is, if the notification target 22 is not reachable, has de-registered, or is associated with an error, the service producer 14P is to reselect the target for the notification to be the notification redundant target 22R.

In some embodiments, the notification redundant target indication 20R takes the form of an address or URI of the notification redundant target 22R. In these and other embodiments, the notification redundant target 22R may take the form of an endpoint and/or a destination URI (or a host part thereof) where the notification 18 is to be sent in case of notification failover. In other embodiments, the notification redundant target indication 20R takes the form of a binding indication, e.g., as specified by 3GPP TS 29.500 V16.9.0. In this case, the binding indication may comprise an NF instance identity, an NF set identity, or an NF service set identity, e.g., so as to bind the notification redundant target 22R to an identified NF instance, NF set, or NF service set.

Having generated the subscription request 16 to include the access token 28, the notification target indication 20, and the notification redundant target indication 20R, the service consumer 14C transmits the subscription request 16 to the service producer 14P. Upon receipt, the service producer 14P checks the access token 28 as part of checking whether the requested subscription is authorized. If verification of the access token 28 fails, meaning that the requested subscription to the notification 18 by the service consumer 14C is unauthorized, the service producer 14P rejects the requested subscription. Otherwise, if verification of the access token 28 succeeds, meaning that the requested subscription to the notification 18 by the service consumer 14C is in fact authorized, the service producer 14P creates the subscription as requested.

If the subscription is created, then the service producer 14P monitors for triggering of the notification 18, e.g., where the notification 18 may be triggered upon the occurrence of an event. Upon triggering of the notification 18, the service producer 14P first selects the notification target 22 indicated by the subscription request 16 as the target for the notification 18. The service producer 14P sends the notification 18 to the notification target 22. If the notification target 22 is reachable, the notification target 22 receives the notification 18 and acknowledges that receipt to the service producer 14P. If the notification target 22 is unreachable, the notification target 22 will not receive the notification 18 and will not acknowledge receipt of the notification 18. Upon determining that the notification target 22 is unreachable, e.g., after failing to receive acknowledgement of the notification 18, the service producer 14P reselects the target for the notification 18. In particular, the service producer 14P this time selects the notification redundant target 22R as the new target for the notification 18. Upon notification target reselection, then, the service producer 14P sends the notification 18 to the notification redundant target 22R.

The access token 28 as described above authorizes subscription by the service consumer 14C to the notification 18 from the service producer 14P. Some embodiments herein exploit this access token 28 also to ensure that the notification redundant target 22R is authorized to receive the notification 18 if the notification target 22 ends up being unreachable. That is, some embodiments herein exploit the access token 28 also to ensure that the notification redundant target 22R is in fact authorized to receive the notification 18 upon notification target reselection. In doing so, some embodiments advantageously prevent an unauthorized target from receiving the notification 18 and/or maintain data confidentiality, even upon notification target reselection.

To this point, FIG. 1 shows that the service consumer 14C includes the notification redundant target indication 20R in the access token request 26. The notification redundant target indication 20R indicates the notification redundant target 22R for reselection of the target for the notification 18. The notification redundant target indication 20R may for instance take the form of a binding indication, e.g., indicating an NF instance identity, NF set identity, or NF service set identity.

Upon receiving the access token request 26, the authentication server 24 verifies that the notification redundant target 22R is authorized to receive the notification 18, e.g., where verification may be based on locally configured policies or authorization information. Such verification may simply mean verifying that the notification redundant target 22R matches an endpoint registered with the authorization server 24, e.g., such the notification redundant target 22R is authorized to receive the notification 18 if the notification redundant target 22R is registered with the authorization server 24. Registration with the authorization server 24 in this regard may mean that the notification redundant target 22R is a legitimate, known target.

If the notification redundant target 22R is verified as being authorized to receive the notification 18, the authentication server 24 includes a notification redundant target claim 30R in the access token 28. This notification redundant target claim 30R is a claim asserting the notification redundant target 22R, i.e., asserting that the notification redundant target 22R is a valid, authorized target for the notification 18. The claim 30R may for instance assert the notification redundant target 22R by asserting a binding indication, where the binding indication indicates the notification redundant target 22R. Regardless, by including such a claim in the access token 28, the access token 28 not only indicates authorization of the subscription by the service consumer 14C to the notification 18 but also indicates authorization of the notification redundant target 22R to receive the notification 18 upon notification target reselection. It is this access token 28, then, that the authentication server 24 provides to the service consumer 14C in response to the access token request 26.

The service producer 14P correspondingly receives the access token 28 in the subscription request 16 from the service consumer 14C. Based on this access token 28, the service producer 14P verifies the notification redundant target 22R indicated by the subscription request 16 as being authorized to receive the notification 18. This may entail, for example, verifying the notification redundant target 22R indicated by the subscription request 16 as being authorized to receive the notification 18 if the notification redundant target 22R indicated by the subscription request 16 is the same as the notification redundant target 22R asserted by the claim 30R of the access token 28. On the other hand, if the notification redundant target 22R indicated by the subscription request 16 is different than the notification redundant target 22R asserted by the claim 30R of the access token 28, the service producer 14P may determine that the notification redundant target 22R indicated by the subscription request 16 is not authorized to receive the notification 18.

In some embodiments, the service producer 14P verifies whether the notification redundant target 22R is authorized as part of deciding whether or not to create the requested subscription. In this case, the service producer 14P rejects the request for the subscription if the notification redundant target 22R is not authorized to receive the notification 18. In other embodiments, the service producer 14P may create the subscription without regard to whether the notification redundant target 22R is authorized to receive the notification 18, and defers verification of the notification redundant target 22R until notification target reselection. Upon notification target reselection, then, the service producer 14P checks whether the notification redundant target 22R is authorized to receive the notification 18 and sends the notification 18 to the notification redundant target 22R only if the notification redundant target 22R is indeed authorized.

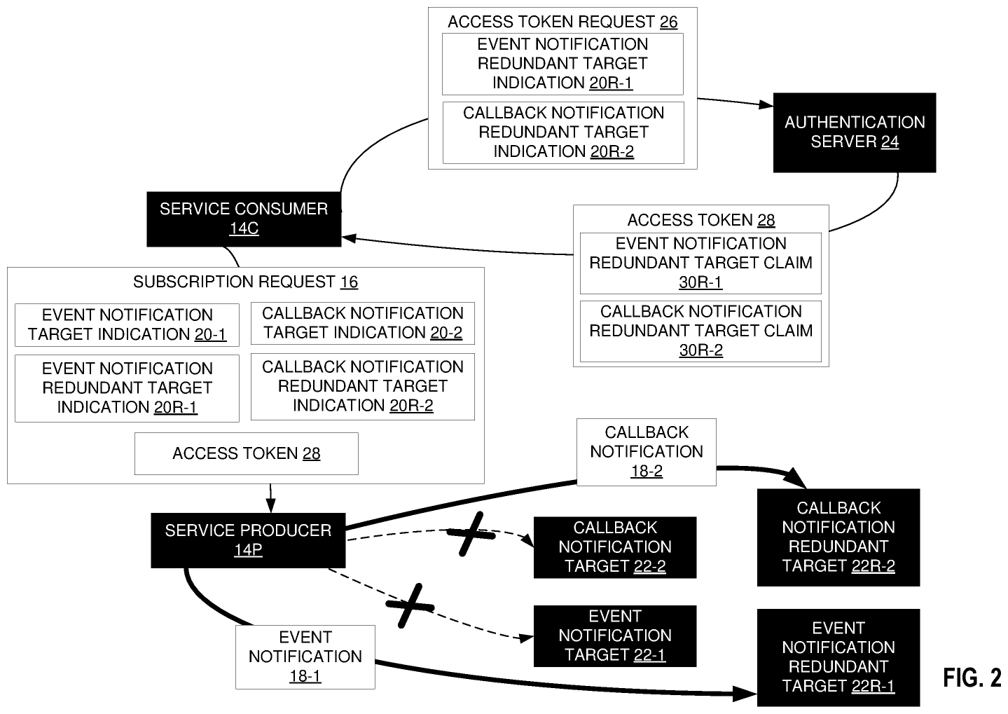

Although FIG. 1 describes the subscription request 16 as requesting subscription to a single notification 18, such need not be the case. Indeed, embodiments herein may be applicable for any number or type of notifications 18 whose subscription is requested by the subscription request 16. Generally, then, the access token 28 requested by the service consumer's subscription request 16 may be for authorizing subscription by the service consumer 14C to multiple notifications from the service producer 14P. In this case, the subscription request 16 may indicate multiple notification redundant targets for notification target reselection associated with the multiple respective notifications, and the access token 28 may include multiple claims respectively asserting the multiple notification redundant targets. FIG. 2 shows one example for two notifications, including a callback notification and a subscription event notification.

As shown in FIG. 2, the access token request 26 includes both an event notification redundant target indication 20R-1 and a callback notification redundant target indication 20R-2. The event notification redundant target indication 20R-1 indicates an event notification redundant target 22R-1 for reselection of a target for a subscription event notification 18-1 if an event notification target 22-1 is unreachable. The callback notification redundant target indication 20R-2 indicates a callback notification redundant target 22R-2 for reselection of a target for a callback notification 18-2 if a callback notification target 22-2 is unreachable.

Upon verifying both the event notification redundant target 22R-1 and the callback notification redundant target 22R-2, the authentication server 24 includes in the access token 28 both an event notification redundant target claim 30R-1 and a callback notification redundant target claim 30R-2. The event notification redundant target claim 30R-1 asserts the event notification redundant target 22R-1 as being authorized to receive the event notification 18-1, whereas the callback notification redundant target claim 30R-2 asserts the callback notification redundant target 22R-2 as being authorized to receive the callback notification 18-2.

The service consumer 14C correspondingly sends the service producer 14P a subscription request 16 that requests subscription to both the subscription event notification 18-1 and the callback notification 18-2. The service consumer 14C includes in the subscription request 16 an event notification target indication 20-1 indicating an event notification target 22-1 to target for the subscription event notification 18-1, as well as a callback notification target indication 20-2 indicating a callback notification target 22-2 to target for the callback notification 18-2. Finally, the service consumer 14C further includes in the subscription request 16 the event notification redundant target indication 20R-1 indicating the event notification redundant target 22R-1 for reselection of the target of the event notification 18-1 in case event notification target 22-1 is unreachable, as well as the callback notification redundant target indication 20R-2 indicating the callback notification redundant target 22R-2 for reselection of the target of the callback notification 18-2 in case callback notification target 22-2 is unreachable. Based on this access token 28, the service producer 14P verifies the event notification redundant target 22R-1 and the callback notification redundant target 22R-2 indicated by the subscription request 16 as being authorized to receive the event notification 18-1 and the callback notification 18-2, respectively.

Consider a specific example where the communication network 10 is exemplified as a 5G network, the service consumer 14C is exemplified as an NF service consumer, the service producer 14P is exemplified as an NF service producer, a notification target is exemplified as a notification endpoint, and a notification redundant target is exemplified as a notification redundant endpoint. Some embodiments ensure a notification service is only provided to an authorized NF routed by a URI in the subscribe request message. Alternatively or additionally, some embodiments prevent information disclosure to an unauthorized NF routed by the URI in the subscribe request message.

In this example, a notification redundant target is indicated via binding information, e.g., Binding Information specified by 3GPP TS 23.501 V16.10.0. In this case, a binding is used to indicate suitable NF consumer instance(s) for notification target reselection and routing of subsequent notification requests associated with a specific notification subscription and for providing Binding Indication for service(s) that the NF consumer produces for the same data context and the NF service producer is subsequently likely to invoke.

During explicit or implicit notification subscription, a Binding Indication may be provided by the NF service consumer to NF service producer; the NF service consumer will also provide a Notification Endpoint. The NF service consumer may also provide a Binding Indication in response to notification requests. The level of Binding Indication provided by the NF service consumer to the NF service provider indicates if the Notification Endpoint is either bound to NF service instance, NF instance, NF Service Set or NF set. The Binding Indication shall include at least one of NF Set ID, NF instance ID, NF Service Set ID and/or NF service instance ID, and may also include the service name. The NF Service Set ID, NF service instance ID, and service name relate to the service of the NF service consumer that will handle the notification.

The Binding Indication is used by the NF service producer as notification sender to reselect an endpoint address and construct the Notification Endpoint, i.e. the URI where the notification is to be sent, e.g. if the provided Notification Endpoint of the NF service consumer included in the subscription cannot be reached, according to the following. If the service name in the Binding Indication is omitted and the binding for notification is on NF Set or NF Instance level, the endpoint address registered in the NRF at NF Profile level of the NF(s) selected according to the Binding Indication shall be used to construct a new Notification Endpoint. If the service name is included in the Binding Indication, an endpoint address registered in the NRF for that service in the NF profile(s) selected according to the Binding Indication shall be used to construct a new Notification Endpoint.

For subscription to notifications via another network function, a separate Binding Indication for subscription related events may be provided by the NF service consumer and if provided shall be associated with an applicability indicating notification for subscription related events.

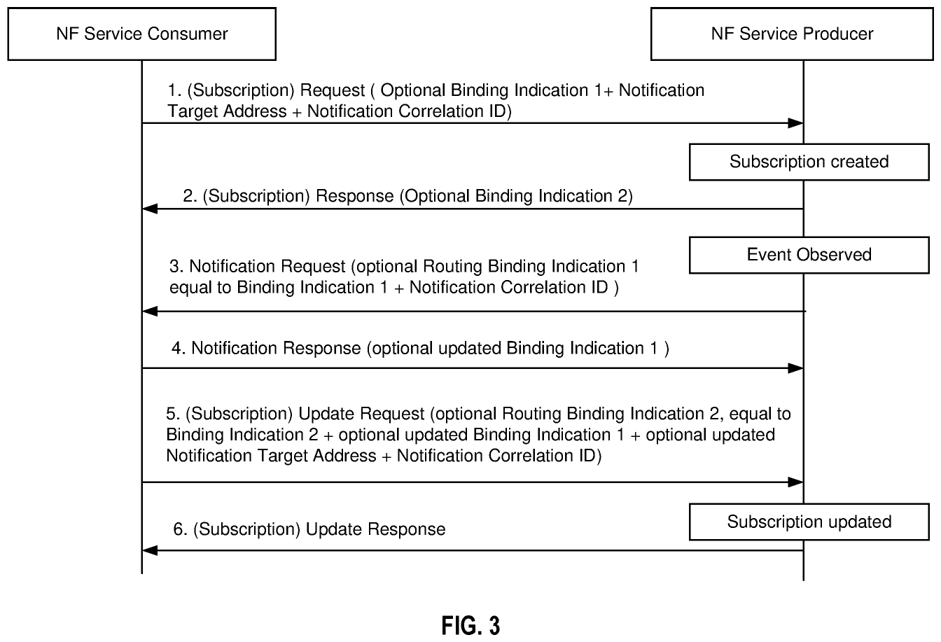

Note that binding for notifications can be created as part of an explicit or implicit subscription request. In this case, illustrated in FIG. 3 (as specified by 3GPP TS 23.502 V16.10.0), the subscription request from the NF service consumer may include a Binding Indication 1 referring to NF service instance, NF service Set, NF instance or NF Set and may additionally include a service name of the NF service consumer. The NF Service Set ID, NF service instance ID, and service name relate to the service of a NF service consumer that will handle the notification.

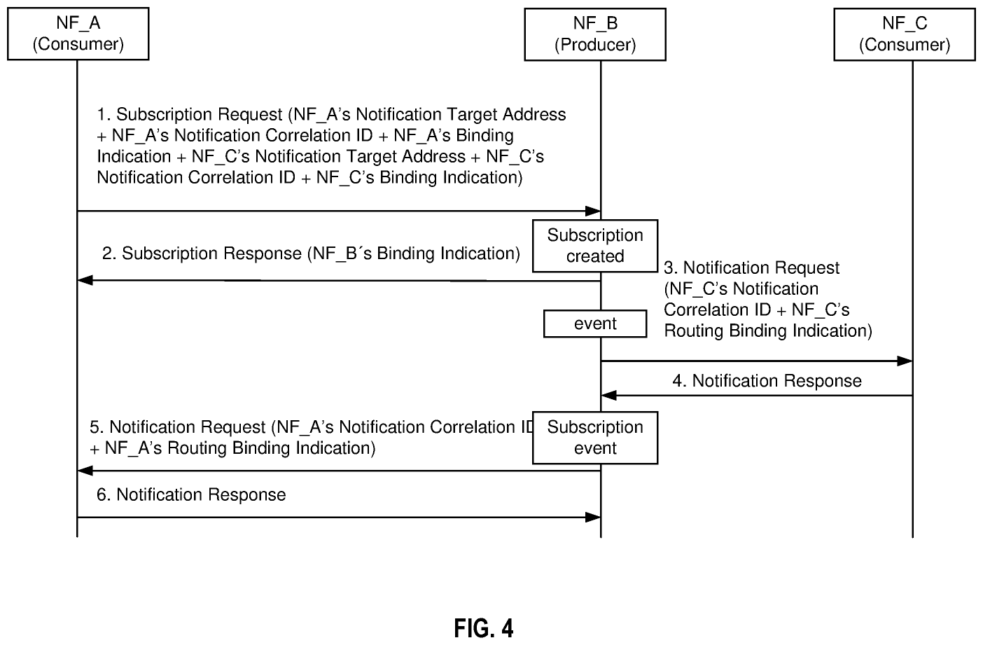

However, an NF service consumer may instead subscribe via another network function, as shown in FIG. 4 (as specified by 3GPP TS 23.502 V16.10.0). For example, as shown, NF_A may subscribe to NF_B on behalf of NF_C. NF_A additionally subscribes to subscription related events. In this case, both the binding indication from NF_C and NF_A are provided to the NF service producer NF_B. The Binding Indication for notifications to subscription related events shall be associated with an applicability indicating “subscription events”.

The NF_C's binding indication is used for reselection of a notification endpoint, which is used for event notification. The NF_A's binding indication is used for reselection of a notification endpoint, which is used for subscription change event notification.

Note that the NF instance can identify the redundancy scope of the resource/context with Binding Indication, which applies to subscription change event notifications or callback notifications:

```
3gpp-Sbi-Binding
    ......
    3gpp-Sbi-Binding = “3gpp-Sbi-Binding” “:” 1#(OWS “bl=” blvalue 1*(“;” OWS parameter)
  [“;” OWS recoverytime] [“;” OWS notif-receiver])
    blvalue  = “nf-instance” / “nf-set” / “nfservice-instance” / “nfservice-set”
    parameter  = parametername “=” token
    parametername  = “nfinst” / “nfset” / “nfservinst” / “nfserviceset” / “servname” /
  “scope” / “backupamfinst”
    recoverytime = “recoverytime=” OWS date-time
    notif-receiver = “nr=” URI  ; URI production rule from IETF RFC 3986
```

Scope indicates the applicability of a Binding Indication in a service request other than a notification request, or in a notification or callback response. This may take one of the following values. The value “other-service” indicates the binding information applies to other service(s) that the NF Service Consumer may later on provide as an NF Service Producer. The value “subscription-events” indicates the binding information applies to subscription change event notifications. The value “callback” indicates the binding information applies to notification or callback requests.

When the NF service consumer subscribes (explicitly or implicitly) to notifications from another NF service producer, the NF service consumer may provide a binding indication to the NF service producer, to enable the related notifications to be sent to an alternative NF service consumer within the NF (service) set, in addition to providing the Callback URI in the subscription resource.

When becoming aware of an NF service consumer change, the NF service producer or SCP shall replace the authority part of the Notification/Callback URI with the new NF service consumer information and shall use that URI in subsequent communications.

When the NF service consumer is changed, and if the new NF service consumer does not support handling notifications, the new NF service consumer should update the NF service producers with the new Notification URI. For explicit subscriptions, this is achieved by updating the existing subscription or creating a new subscription, depending on the NF service producer's API. For implicit subscriptions, this is carried out via a service update request message.

The new NF service consumer may include an updated binding indication in a service request or notification response message to the NF service producer.

Each NF service consumer within the NF (service) set shall be prepared to receive notifications from the NF service producer, either by handling the notifications to the Notification URI constructed with its own address as authority part, by handling the notifications to the Notification URI, or by replying with an HTTP 3xx redirect pointing to a new NF service consumer or with another HTTP error. When becoming aware of an NF service consumer change, and if binding information is available and the binding mechanism is supported by the NF service producer, the reselection should be based on the binding information.

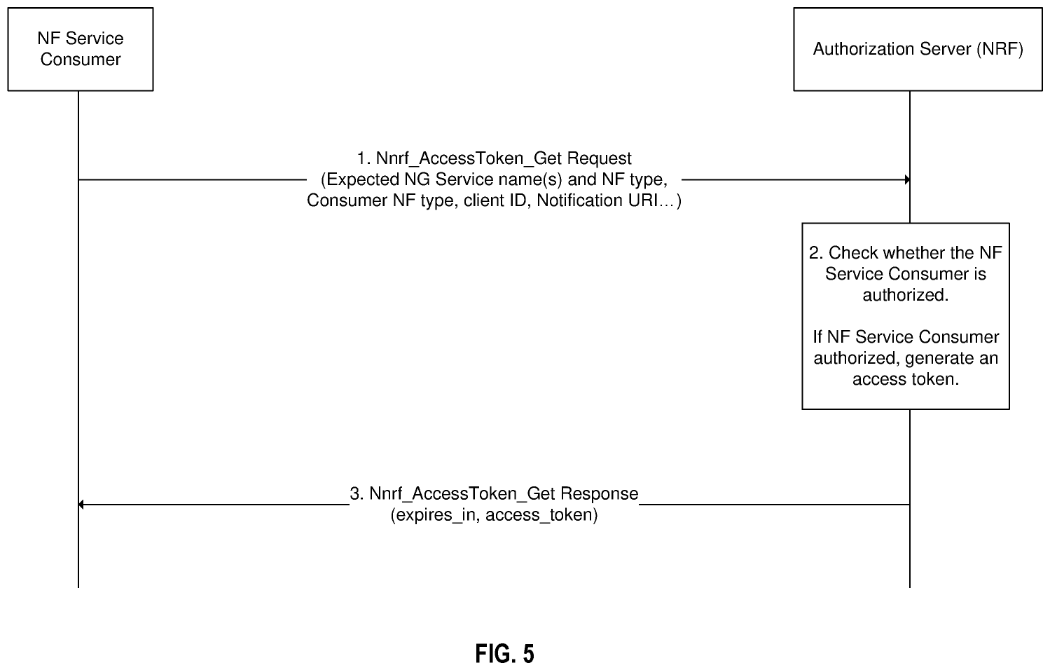

In some embodiments, the actual notification endpoint can be authorized using a token-based authorization mechanism, as shown in FIG. 5 (cited from 3GPP TR 33.875 V 0.4.0). The notification URI is included both in the access token request and the granted access token.

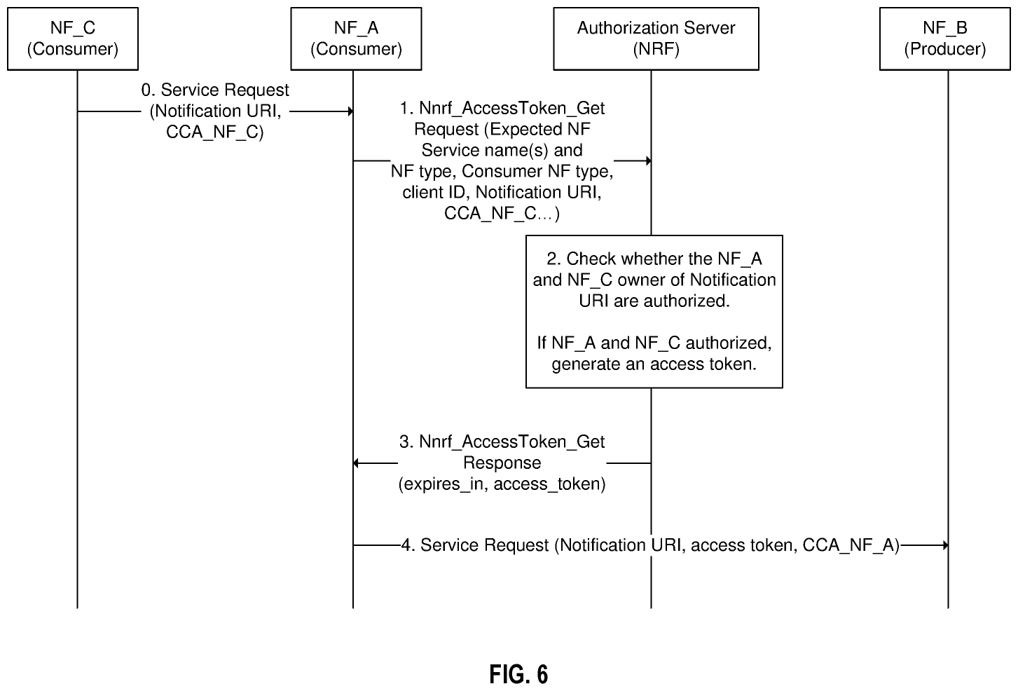

FIG. 6 (cited from 3GPP TR 33.875 V 0.4.0) shows the full procedure, including the service request from NF_C to NF_A, and the service request from NF_A to NF_B on behalf of NF_C. The producer NF_B checks whether the notification URI of NF_C is included in the access token presented by NF_C. If the check is successful, NF_B sends the notification to NF_C. Note that, instead of the full notification URI, only the host address could be used for authorization.

In this context, some embodiments ensure notification service is provided only to an authorized NF even when routed by a Binding Indication during notification failover handling. Some embodiments furthermore maintain data confidentiality to an unauthorized NF routed by a Binding Indication during notification failover handling.

Some embodiments for example introduce two new attributes in the AccessTokenClaims, to indicate the authorized NF (service) instance(s) for notification target reselection.

In general, there may be two kinds of event notifications associated with one subscription (callback notification and subscription change event notification) which can be distributed to different NF service consumers. In some embodiments, then, two Information Elements (IEs) are defined to indicate the redundant notification endpoints (represent by a NF instance ID, a NF Set Id or a NF Service Set ID) for each event notification respectively. That is, some embodiments introduce two new optional attributes to the existing definition of type AccessTokenClaims, to indicate the authorized NF (service) instances associated with a Binding Indication, which is to be used for notification target reselection.

As an example, some embodiments define the AccessTokenClaims in an access token as shown below:

Definition of type Access TokenClaims

| | Data | | | |
|---|---|---|---|---|
| Attribute name | type | P | Cardinality | Description |
| callbackNotificationRe | String | O | 0 . . . 1 | When present, this IE |
| dundantEndpoints | | | | shall contain a NF |
| | | | | instance ID, or a NF |
| | | | | Service Set ID, or a |
| | | | | NF Set ID, to identify |
| | | | | the authorized NF |
| | | | | (service) instance(s) |
| | | | | for callback |
| | | | | notification target |
| | | | | reselection. |
| subscriptionEventNtifi | String | O | 0 . . . 1 | When present, this IE |
| cationRedundantEnd | | | | shall contain a NF |
| points | | | | instance ID, or a NF |
| | | | | Service Set ID, or a |
| | | | | NF Set ID, to identify |
| | | | | the authorized NF |
| | | | | (service) instance(s) |
| | | | | for subscription |
| | | | | change event |
| | | | | notification target |
| | | | | reselection. |

In this case, the callbackNotificationRedundantEndpoints IE in the AccessTokenClaims is an example of the notification redundant target claim 30R in FIG. 1 in the case where the notification 18 is a callback notification. As another example, the subscriptionEventNtificationRedundantEndpoints IE in the AccessTokenClaims is an example of the notification redundant target claim 30R in FIG. 1 in the case where the notification 18 is a subscription event notification.

For simplicity, all not relevant attributes in the table are removed. The two new attribute names are just examples.

In other embodiments, the new IEs could also contain a list of notification URIs, corresponding to NF instances in an NF Set, or NF Service instances in an NF Service Set. Instead of the full URIs, only the host names could also be included.

The following procedure illustrates how the notification redundant targets of NF Service Consumers is added in the access token and is verified by NF Service Producer during notification failover procedure according to some embodiments.

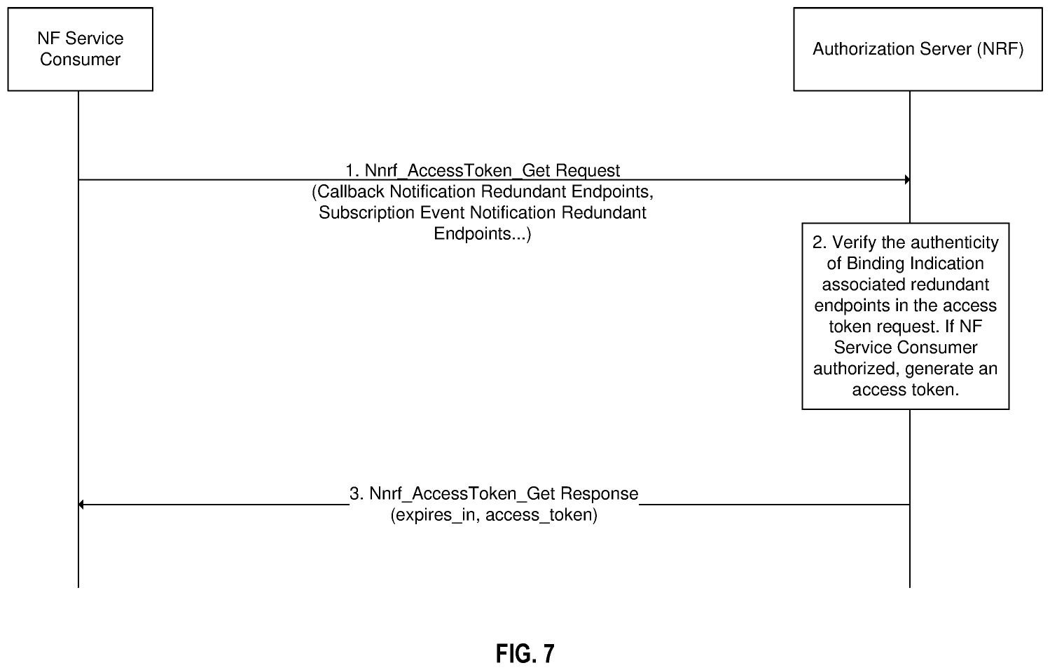

Step 1: NF Service Consumer requests an access token for an explicit or implicit subscription request. FIG. 7 shows one example in this regard. As shown in FIG. 7, the NF Service Consumer requests an access token from the NRF using the Nnrf_AccessToken_Get request operation (Substep 1), regardless if the access token request is for accessing services of NF Service Producers of a specific NF type, or for accessing services of a specific NF Service Producer instance/NF Service Producer service instance. When a Binding Indication of the subscription is received, the message shall include the Binding Indication associated redundant endpoints that receives callback notification, and the Binding Indication associated redundant endpoints that receives subscription change event notification. These Binding Indications exemplify the callback notification redundant target indication 20R-2 and the event notification redundant target indication 20R-1 in FIG. 2. In Substep 2 of FIG. 7, the NRF shall verify that the Binding Indication associated redundant endpoints in the access token request are authorized and correct. This may include that the NRF checks that the endpoints match with the corresponding one registered in the NF (service) profile. If the NF Service Consumer is authorized, the NRF shall then generate an access token with appropriate claims included. The claims shall include the verified Binding Indication associated redundant endpoints that receive callback notification, as an example of callback notification redundant target claim 30R-2. The message shall also include the verified Binding Indication associated redundant endpoints that receive subscription change event notification, as an example of event notification redundant target claim 30R-1. In subbstep 3 of FIG. 7, if the authorization is successful, the NRF shall send access token to the NF Service Consumer in the Nnrf_AccessToken_Get response operation; otherwise it shall reply based on Oauth 2.0 error response defined in RFC 6749.

Step 2: NF Service Consumer sends the explicit or implicit subscription request to the NF Service Producer, including the access token and the Binding Indications.

Step 3: NF Service Producer stores the access token and Binding Indications received from an explicit or implicit subscription request.

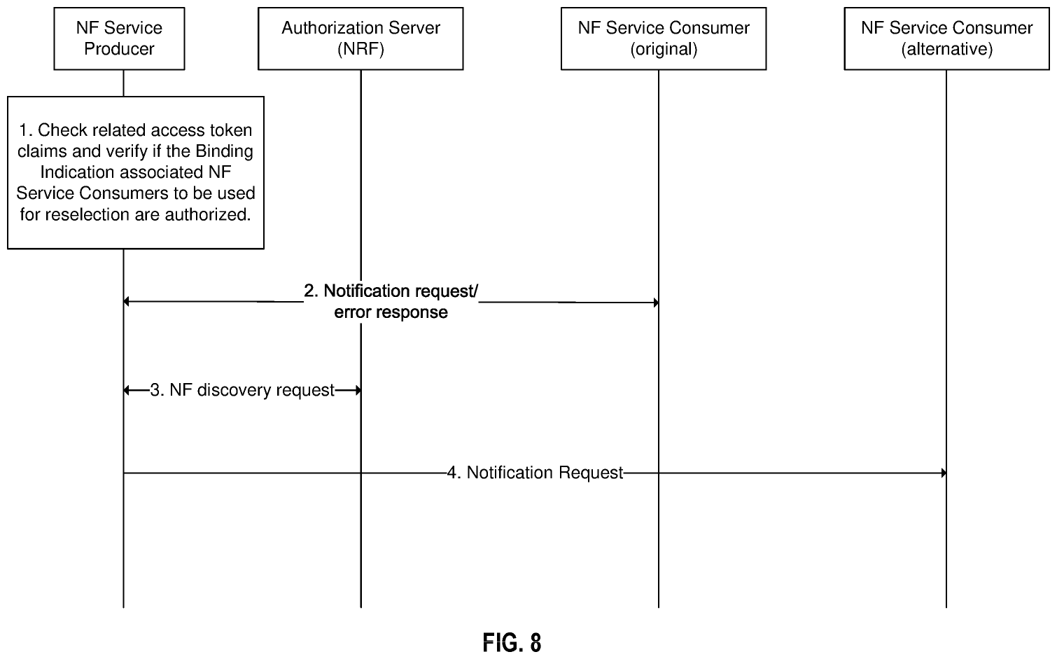

Step 4: Upon notification target reselection, NF Service Producer resends a notification to a new NF Service Consumer instance indicated by the Binding Indication. FIG. 8 illustrates additional details of Step 4 according to some embodiments.

In substep 1 of FIG. 8, prior to the notification resending, the NF Service Producer verifies if the NF Service Consumer instances to be used for reselection are authorized. If an NF Set ID or NF Service Set Id or NF Instance ID was included in the previously received Binding Indication, the NF Service Producer shall check if the provided ID in the Binding Indication matches the ID in the access token claim. If a URI or hostname is included in the access token claim, the NF Service producer checks whether the URI matches the endpoint of the notification to be sent.

In substep 2, if the verification is successful, the NF Service Producer sends a notification request to the original NF Service Consumer. In case of indirect communication mode, the NF Service Producer copies the authorized Binding Indication into the Routing Binding Indication. The notification request may fail due to either no response or an error originated by the NF Service Consumer.

In substep 3, the NF Service Producer selects an alternative NF Service Consumer according to the Binding Indication, discovers the related notification endpoint address registered in the NRF at NF (service) Profile level of the NF, and uses it to construct a new Notification Endpoint.

In substep 4, the NF Service Producer re-sends the notification to the alternative NF Service Consumer.

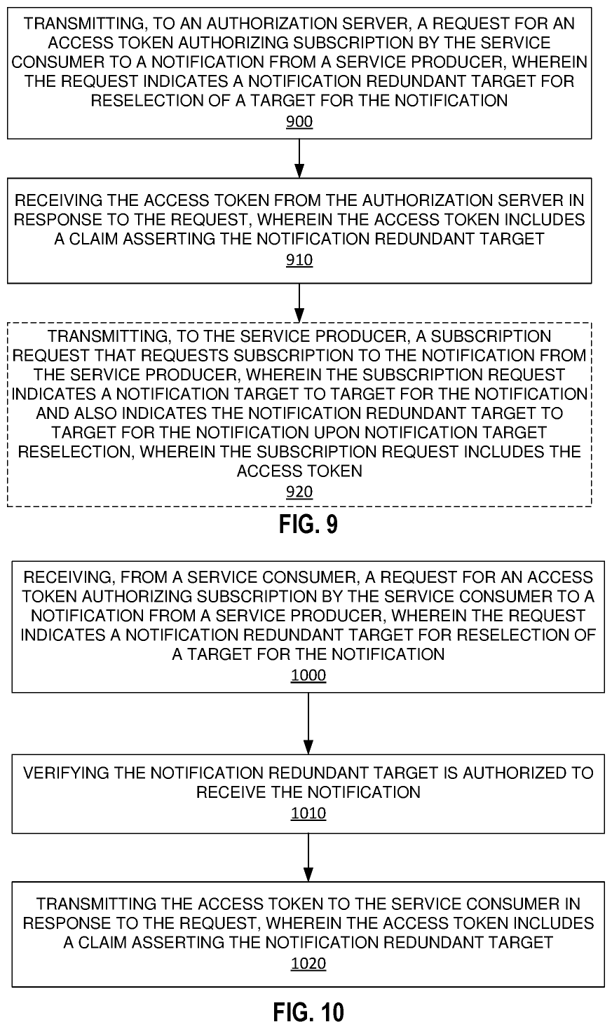

In view of the modifications and variations herein, FIG. 9 depicts a method performed by network equipment 1200 configured to operate as a service consumer 14C in accordance with particular embodiments. The method includes transmitting, to an authorization server 24, a request 26 for an access token 28 authorizing subscription by the service consumer 14C to a notification 18 from a service producer 14P (Block 900). The notification 18 may for example be a callback notification or a subscription event notification. Regardless, the request 26 indicates a notification redundant target 22R for reselection of a target for the notification. In some embodiments, for example, the notification redundant target 22R is to be selected as a target for the notification in case a notification target 22 indicated by a request 16 for a subscription to the notification 18 is not reachable.

In some embodiments, the request includes a binding indication that indicates the notification redundant target 22R. In one or more of these embodiments, the binding indication comprises a network function, NF, instance identity, an NF set identity, or an NF service set identity.

The method also comprises receiving the access token 28 from the authorization server 24 in response to the request 26 (Block 910). The access token 28 includes a claim asserting the notification redundant target 22R.

In some embodiments, the method also comprises transmitting, to the service producer 14P, a subscription request 16 that requests subscription to the notification 18 from the service producer 14P (Block 920). In this case, the subscription request 16 indicates a notification target 22 to target for the notification 18 and also indicates the notification redundant target 22R to target for the notification 18 upon notification target reselection. Furthermore, the subscription request 16 includes the access token 28.

In some embodiments, the access token 28 requested by the request 16 is for authorizing subscription by the service consumer 14C to multiple notifications 18-1, 18-2 from the service producer 14P, e.g., a callback notification and a subscription event notification. In one or more such embodiments, the request indicates multiple notification redundant targets 22R-1, 22R-2 for notification target reselection associated with the multiple respective notifications 18-1, 18-2, and the access token 28 includes multiple claims 30R-1, 30R-2 respectively asserting the multiple notification redundant targets 22R-1, 22R-2.

FIG. 10 depicts a method performed by an authorization server 24 in accordance with other particular embodiments. The method comprises receiving, from a service consumer 14C, a request 26 for an access token 28 authorizing subscription by the service consumer 14C to a notification 18 from a service producer 14P, e.g., a callback notification or a subscription event notification (Block 1000). In some embodiments, the request 26 indicates a notification redundant target 22R for reselection of a target for the notification 18. In some embodiments, for example, the notification redundant target 22R is to be selected as a target for the notification 18 in case a notification target 22 indicated by a subscription to the notification 18 is not reachable.

In some embodiments, the request 26 includes a binding indication that indicates the notification redundant target 22R. In one or more of these embodiments, the binding indication comprises a network function, NF, instance identity, an NF set identity, or an NF service set identity.

Regardless, the method also comprises verifying the notification redundant target 22R is authorized to receive the notification 18 (Block 1010). In some embodiments, for example, verifying the notification redundant target 22R is authorized to receive the notification 18 comprises verifying that the notification redundant target 22R matches an endpoint registered with the authorization server 24.

In any event, the method also comprises transmitting the access token 28 to the service consumer 14C in response to the request 26 (Block 1020). In some embodiments, the access token 28 includes a claim 30R asserting the notification redundant target 22R.

In some embodiments, the access token 28 requested by the request 26 is for authorizing subscription by the service consumer 14C to multiple notifications 18-1, 18-2 from the service producer 14P. In some embodiments, the request 26 indicates multiple notification redundant targets 22R-1, 22R-2 for notification target reselection associated with the multiple respective notifications 18-1, 18-2, and the access token 28 includes multiple claims 30R-1, 30R-2 respectively asserting the multiple notification redundant targets 22R-1, 22R-2. In one or more of these embodiments, the multiple notifications 18-1, 18-2 include a callback notification and a subscription event notification.

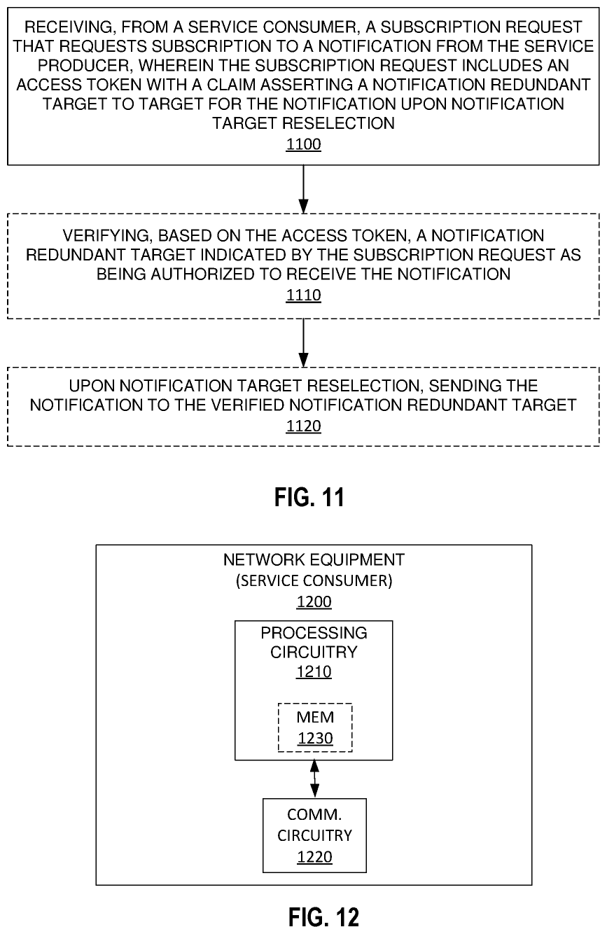

FIG. 11 depicts a method performed by network equipment 1400 configured to operate as a service producer 14P. The method comprises receiving, from a service consumer 14C, a subscription request 16 that requests subscription to a notification 18 from the service producer 14P, e.g., a callback notification or a subscription event notification (Block 1100). In some embodiments, the subscription request 16 includes an access token 28 with a claim 30R asserting a notification redundant target 22R to target for the notification 18 upon notification target reselection. In one embodiment, for example, the notification redundant target 22R is an endpoint to be selected as a target for the notification in case a notification target 22 indicated by a request 16 for the subscription requested is not reachable.

In some embodiments, the subscription request 16 indicates a notification redundant target 22R to target for the notification 18 upon notification target reselection. In one or more such embodiments, the method further comprises verifying, based on the access token 28, the notification redundant target 22R indicated by the subscription request 16 as being authorized to receive the notification 18 (Block 1110). In one or more of these embodiments, this verifying comprises verifying the notification redundant target 22R indicated by the subscription request 16 as being authorized to receive the notification 18 if the notification redundant target 22R indicated by the subscription request 16 is the same as the notification redundant target 22R asserted by the claim of the access token 28. Regardless, in some embodiments, the method further comprises, upon notification target reselection, sending the notification 18 to the verified notification redundant target 22R (Block 1120).

Embodiments herein also include corresponding apparatuses. Embodiments herein for instance include network equipment configured to operate as a service consumer 14C by performing any of the steps of any of the embodiments described above for the service consumer 14C.

Embodiments also include network equipment that is configured to operate as a service consumer 14C and that comprises processing circuitry and power supply circuitry. The processing circuitry is configured to perform any of the steps of any of the embodiments described above for the service consumer 14C. The power supply circuitry is configured to supply power to the network equipment.

Embodiments further include network equipment that is configured to operate as a service consumer 14C and that comprises processing circuitry. The processing circuitry is configured to perform any of the steps of any of the embodiments described above for the service consumer 14C. In some embodiments, the network equipment further comprises communication circuitry.

Embodiments also include network equipment that is configured to operate as a service consumer 14C and that comprises processing circuitry and memory. The memory contains instructions executable by the processing circuitry whereby the network equipment is configured to perform any of the steps of any of the embodiments described above for the service consumer 14C.

Embodiments herein also include an authentication server 24 configured to perform any of the steps of any of the embodiments described above for the authentication server 24.

Embodiments also include an authentication server 24 comprising processing circuitry and power supply circuitry. The processing circuitry is configured to perform any of the steps of any of the embodiments described above for the authentication server 24. The power supply circuitry is configured to supply power to the authentication server 24.

Embodiments further include an authentication server 24 comprising processing circuitry. The processing circuitry is configured to perform any of the steps of any of the embodiments described above for the authentication server 24. In some embodiments, the authentication server 24 further comprises communication circuitry.

Embodiments further include an authentication server 24 comprising processing circuitry and memory. The memory contains instructions executable by the processing circuitry whereby the authentication server 24 is configured to perform any of the steps of any of the embodiments described above for the authentication server 24.

Embodiments herein further include network equipment configured to operate as a service producer 14P by performing any of the steps of any of the embodiments described above for the service producer 14P.

Embodiments also include network equipment that is configured to operate as a service producer 14P and that comprises processing circuitry and power supply circuitry. The processing circuitry is configured to perform any of the steps of any of the embodiments described above for the service producer 14P. The power supply circuitry is configured to supply power to the network equipment.

Embodiments further include network equipment that is configured to operate as a service producer 14P and that comprises processing circuitry. The processing circuitry is configured to perform any of the steps of any of the embodiments described above for the service producer 14P. In some embodiments, the network equipment further comprises communication circuitry.

Embodiments also include network equipment that is configured to operate as a service producer 14P and that comprises processing circuitry and memory. The memory contains instructions executable by the processing circuitry whereby the network equipment is configured to perform any of the steps of any of the embodiments described above for the service producer 14P.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

FIG. 12 for example illustrates network equipment 1200 configured to operate as a service consumer 14C as implemented in accordance with one or more embodiments. As shown, the network equipment 1200 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the wireless communication device 1200. The processing circuitry 1210 is configured to perform processing described above, e.g., in FIG. 9, such as by executing instructions stored in memory 1230. The processing circuitry 1210 in this regard may implement certain functional means, units, or modules.

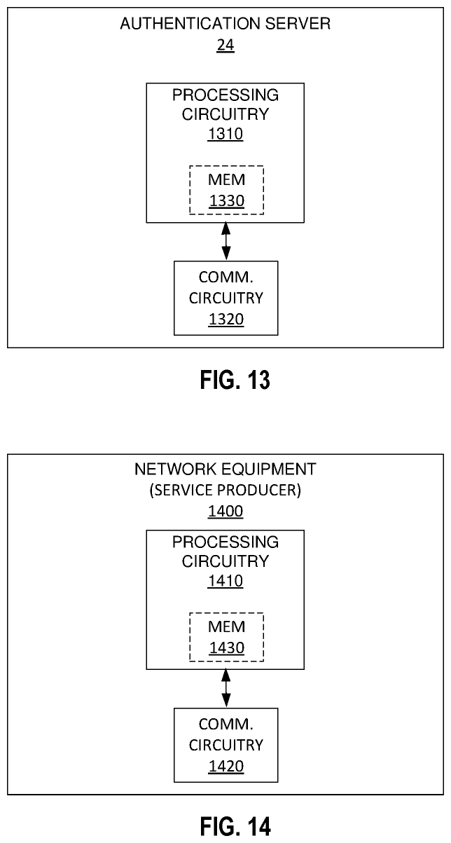

FIG. 13 illustrates an authentication server 24 as implemented in accordance with one or more embodiments. As shown, the authentication server 24 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 10, such as by executing instructions stored in memory 1330. The processing circuitry 1310 in this regard may implement certain functional means, units, or modules.

FIG. 14 illustrates network equipment 1400 configured to operate as a service producer 14P as implemented in accordance with one or more embodiments. As shown, the network equipment 1400 includes processing circuitry 1410 and communication circuitry 1420. The communication circuitry 1420 (e.g., radio circuitry) is configured to transmit and/or receive information to and/or from one or more other nodes, e.g., via any communication technology. Such communication may occur via one or more antennas that are either internal or external to the wireless communication device 1400. The processing circuitry 1410 is configured to perform processing described above, e.g., in FIG. 11, such as by executing instructions stored in memory 1430. The processing circuitry 1410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

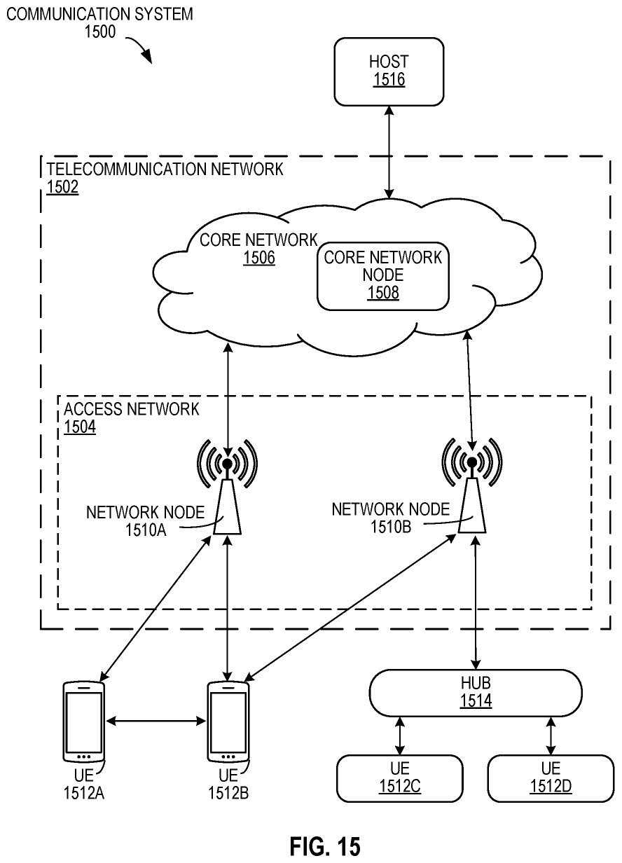

FIG. 15 shows an example of a communication system 1500 in accordance with some embodiments, as exemplifying the communication network 10 of FIG. 1 within which some embodiments herein may be implemented.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3^{rd} Generation Partnership Project (3GPP) access node or non-3GPP access point. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

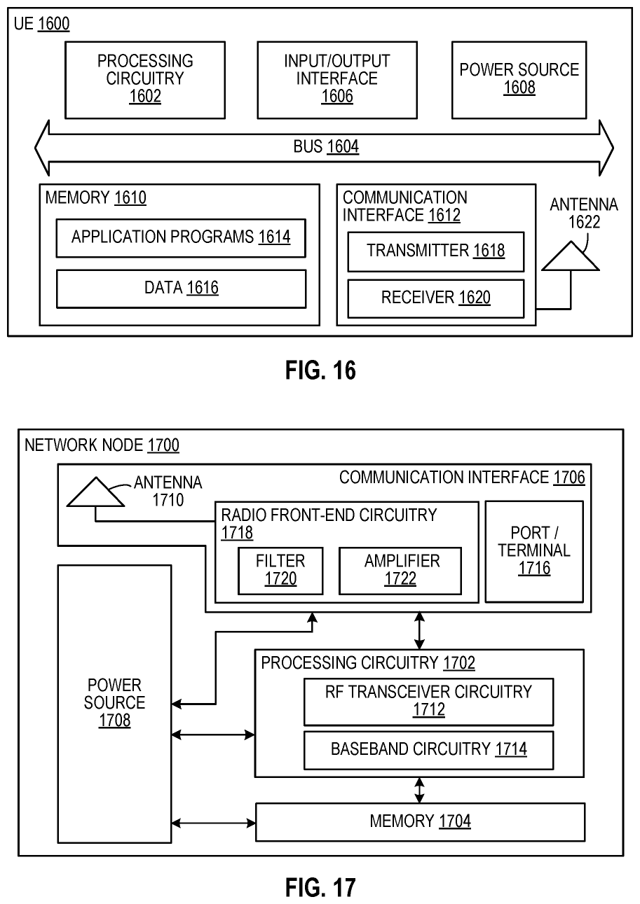

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

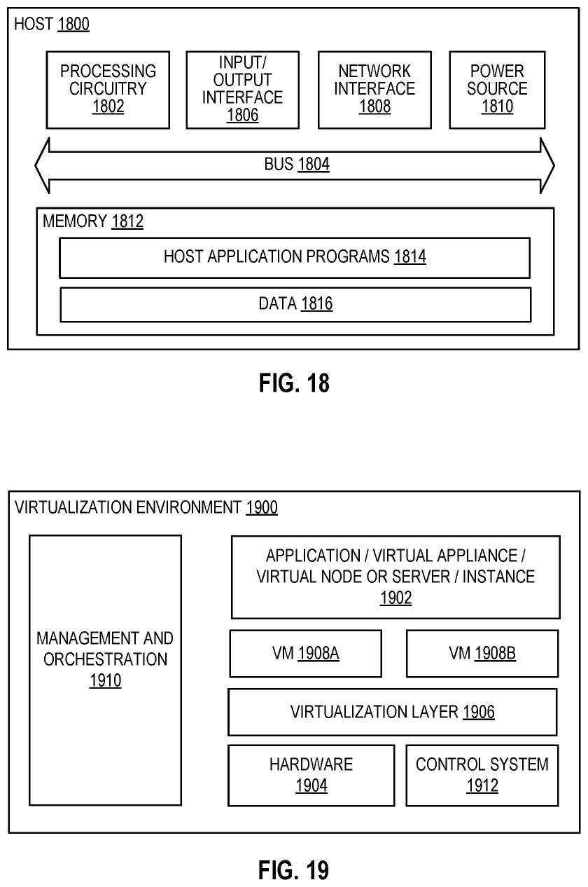

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

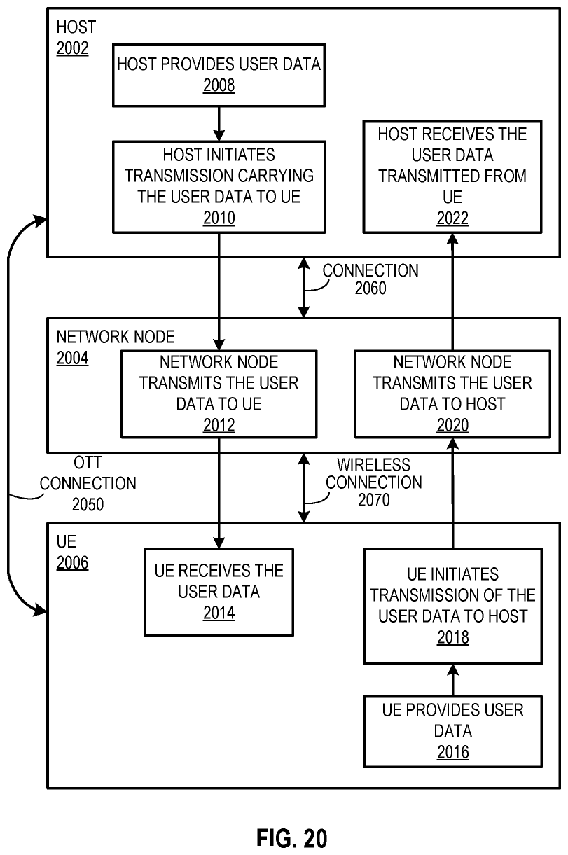

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed disclosure will come to mind to one skilled in the art having the benefit of the teachings presented in the foregoing descriptions and the associated drawings. Therefore, it is to be understood that the disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-35. (canceled)

36. A method performed by network equipment configured to operate as a service consumer, the method comprising:
transmitting, to an authorization server, a request for an access token authorizing subscription by the service consumer to a notification from a service producer, wherein the request indicates a notification redundant target for reselection of a target for the notification; and
receiving the access token from the authorization server in response to the request, wherein the access token includes a claim asserting the notification redundant target.

37. The method of claim 36, further comprising transmitting, to the service producer, a subscription request that requests subscription to the notification from the service producer, wherein the subscription request indicates a notification target to target for the notification and also indicates the notification redundant target to target for the notification upon notification target reselection, wherein the subscription request includes the access token.

38. A method performed by an authorization server, the method comprising:
receiving, from a service consumer, a request for an access token authorizing subscription by the service consumer to a notification from a service producer, wherein the request indicates a notification redundant target for reselection of a target for the notification;
verifying the notification redundant target is authorized to receive the notification; and
transmitting the access token to the service consumer in response to the request, wherein the access token includes a claim asserting the notification redundant target.

39. The method of claim 38, wherein verifying the notification redundant target is authorized to receive the notification comprises verifying that the notification redundant target matches an endpoint registered with the authorization server.

40. The method of claim 36, wherein the notification redundant target is to be selected as a target for the notification in case a notification target indicated by a request for a subscription to the notification is not reachable, has de-registered, or is associated with an error.

41. The method of claim 36, wherein the request includes a binding indication that indicates the notification redundant target.

42. The method of claim 41, wherein the binding indication comprises a network function (NF) instance identity, an NF set identity, or an NF service set identity.

43. The method of claim 36, wherein the notification is a callback notification or a subscription event notification.

44. The method of claim 36, wherein the access token requested by the request is for authorizing subscription by the service consumer to multiple notifications from the service producer, wherein the request indicates multiple notification redundant targets for notification target reselection associated with the multiple respective notifications, and wherein the access token includes multiple claims respectively asserting the multiple notification redundant targets.

45. The method of claim 44, wherein the multiple notifications include a callback notification and a subscription event notification.

46. A method performed by network equipment configured to operate as a service producer, the method comprising:
receiving, from a service consumer, a subscription request that requests subscription to a notification from the service producer, wherein the subscription request includes an access token with a claim asserting a notification redundant target to target for the notification upon notification target reselection.

47. The method of claim 46, wherein the subscription request indicates a notification redundant target to target for the notification upon notification target reselection, and wherein the method further comprises verifying, based on the access token, the notification redundant target indicated by the subscription request as being authorized to receive the notification.

48. The method of claim 47, wherein said verifying comprises verifying the notification redundant target indicated by the subscription request as being authorized to receive the notification if the notification redundant target indicated by the subscription request is the same as the notification redundant target asserted by the claim of the access token.

49. The method of claim 47, further comprising, upon notification target reselection, sending the notification to the verified notification redundant target.

50. The method of claim 46, wherein the notification redundant target is an endpoint to be selected as a target for the notification in case a notification target indicated by the subscription requested is not reachable, has de-registered, or is associated with an error.

51. The method of claim 46, wherein the claim asserts the notification redundant target by asserting a binding indication, wherein the binding indication indicates the notification redundant target.

52. The method of claim 48, wherein the notification is a callback notification or a subscription event notification.

53. The method of claim 48, wherein the subscription request requests subscription to multiple notifications from the service producer, wherein the access token includes multiple claims respectively asserting multiple notification redundant targets to target for the multiple respective notifications upon notification target reselection.

54. The method of claim 53, wherein the multiple notifications include a callback notification and a subscription event notification.

55. Network equipment configured to operate as a service consumer, the network equipment comprising:
communication circuitry; and
processing circuitry configured to:
transmit, to an authorization server, a request for an access token authorizing subscription by the service consumer to a notification from a service producer, wherein the request indicates a notification redundant target for reselection of a target for the notification; and
receive the access token from the authorization server in response to the request, wherein the access token includes a claim asserting the notification redundant target.
